(19) United States
(12) Patent Application Publication
(10) Pub. No.: US 2006/0072310 A1
(43) Pub. Date: Apr. 6, 2006

(54) FLASHLIGHT

(75) Inventor: Cheng-Pin Hung, Taipei City (TW)

Correspondence Address: BACON & THOMAS, PLLC, 625 SLATERS LANE, FOURTH FLOOR, ALEXANDRIA, VA, 22314, US

(73) Assignee: COMART CORPORATION, Taipei City (TW)

(21) Appl. No.: 10/956,148

(22) Filed: Oct. 4, 2004

(51) Int. Cl. F21L 4/00

(52) U.S. Cl. 362/205

(57) ABSTRACT

The flashlight has on its lamp holder a movable member able to move into the lamp holder, the movable member is fixedly provided with an electric conductive strip; and has a restorable spring to normally push the movable member out of the lamp holder that is normally kept in a position to render the electric conductive strip to contact with the contact point of the circuit board. When the flashlight is turned on, a light source is created by electric connecting of a light emitting element effected by an electric conductive strip. When the flashlight is laid upside down with the lamp holder facing downwards to be not in use for a moment, by the weight of the flashlight, the movable member is moved into the lamp holder to release the electric conductive strip from contact with the contact point of the circuit board, hence the light emitting member is electrically broken, and a function of saving electric energy can be obtained.

### BACKGROUND OF THE INVENTION

1. Field of the Invention

The present invention is related to a flashlight adopting an electric-power control technique, and especially to a flashlight which can be immediately out of electric power connecting when it is not in use and is laid upside down with its lamp holder facing downwards, thereby electric energy can be saved; the flashlight particularly suits dentists or professional technicians to maintain and repair equipments.

2. Description of the Prior Art

Normal flashlights and fixed illuminating lamps are same in giving the function of illuminating; but a flashlight has a structure designed to be lighter, it is convenient for a user to change direction of irradiation of its light source at will, in certain cases (such as in seeing patients of a doctor, in the operation of maintenance and repairing and in outdoor activities at night etc.), a flashlight is more convenient and practicable than a fixed illuminating lamp. By virtue that a flashlight shall have the nature of convenience for picking and moving, it must be provided in itself with a power source, mostly such power source is the electric power of batteries mounted in the flashlight, hence the time of using the flashlight is limited by the amount of electricity of the batteries.

Thereby, flashlights in the markets mostly are provided with switches to control electric connection of the electric power of batteries, in order that users can turn on/off switches to lighten or extinguish the light of the flashlights; flashlights normally seen presently mostly each has only the effect of control formed by a single-switching switch or a single-pressing switch, thereby a user can only get the object of making a flashlight electrically break by repeated operating a switch when not in use, such mode of repeated operating a switch not only is subjected to rendering damage of the switch, but also is probable to have the case that when a doctor uses a flashlight to see patients, he is inconvenient to operate the switch just because he wears a pair of gloves, even when he wears a pair of gloves to do his best to avoid infection of germs of diseases that hide in the switch to thereby to reduce the times of operating. And most people let flashlights keep their state of illuminating all the way they work; hence unnecessary power wasting can be resulted.

### SUMMARY OF THE INVENTION

The flashlight of the present invention mainly is provided on its lamp holder with a movable member able to move into the lamp holder, this movable member is fixedly provided with an electric conductive strip; and has a restorable spring to normally push the movable member out of the lamp holder.

Thereby, when the flashlight is in the state of normal use with the switch turned on, the movable member is kept in the position being pushed out of the lamp holder under the action of the restorable spring, this can make the electric conductive strip contact with a contact point of a circuit board, light source can be created by electric connecting of a light emitting element effected by the electric conductive strip.

Moreover, when the user lays the flashlight upside down with its lamp holder facing downwards to be not in use for the moment, the switch of the flashlight is not yet turned off at this time, however, by the weight of the flashlight, the movable member is moved into the lamp holder correspondingly to release the electric conductive strip from contact with the contact point of the circuit board, hence the light emitting member is electrically broken, thereby a function of saving electric energy can be obtained. When the user picks up the flashlight thereafter, the movable member immediately is kept in the position being pushed out of the lamp holder, thereby the flashlight can restore the normal state of use to emit light, and the effect of convenient use and saving electric energy can be achieved.

The present invention will be apparent in its structural combination and entire mode of operation after reading the detailed description of the preferred embodiment thereof in reference to the accompanying drawings.

### BRIEF DESCRIPTION OF THE DRAWINGS

FIG. 1 is a perspective view of the flashlight of the present invention;

FIG. 2 is an analytic perspective view of the flashlight of the present invention;

FIG. 3 is a sectional schematic view showing the structure of the present invention in which the movable member is pushed out of the lamp holder;

FIG. 4 is a sectional schematic view showing the structure of the present invention in which the movable member is pushed into the lamp holder.

### DETAILED DESCRIPTION OF THE PREFERRED EMBODIMENT

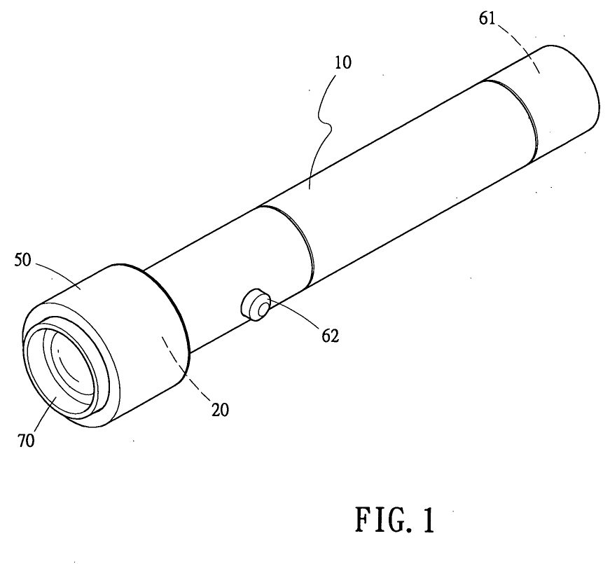

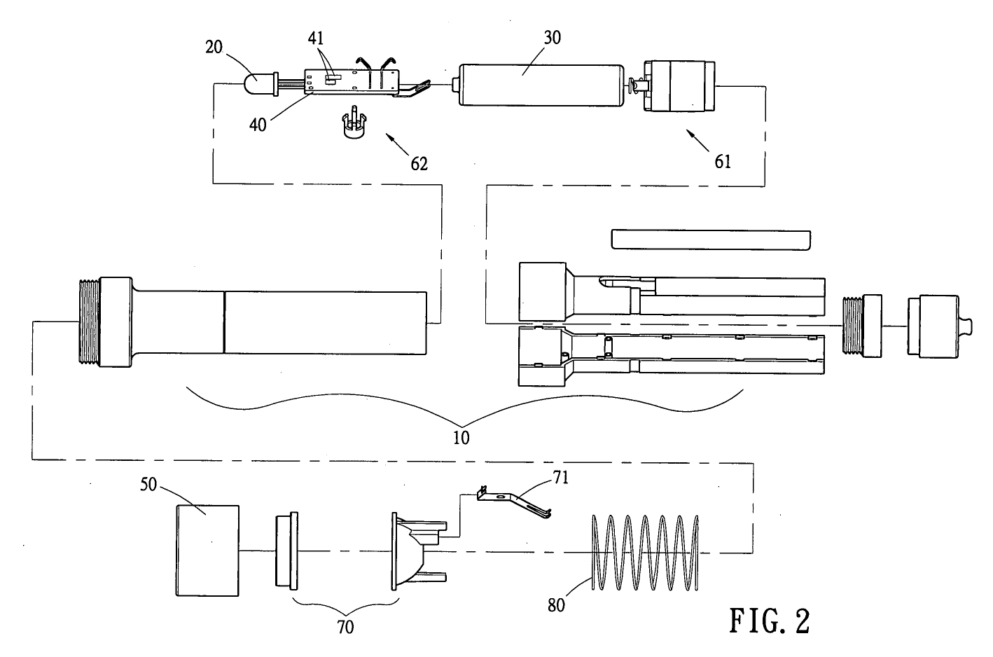

Referring firstly to FIGS. 1-3 showing the basic structural combination of the flashlight of the present invention, the flashlight has a cylindrical housing 10 as its main body, the housing 10 is used to receive a light emitting element 20, a battery 30, an electric circuit board 40 and a switch etc.; the housing 10 is provided on one end with a lamp holder 50, the light source of the light emitting element 20 can be concentrated and irradiated from the lamp holder 50 to elevate the quality of irradiation of the light source.

Wherein the lamp holder 50 is screw connected with one end of the housing 10; the switch includes a rotating switch assembly 61 provided on the other end of the housing 10 which is the end opponent to the lamp holder 50, and a pressing switch assembly 62 near to the lamp holder 50 of the housing 10. The rotating switch assembly 61 and the pressing switch assembly 62 control connecting of the electric circuit board 40 with the battery 30, and the rotating switch assembly 61 can be released from the other end of the housing 10 in favor of changing the battery 30. By providing the abovementioned rotating switch assembly 61 and pressing switch assembly 62, a user can rotate the rotating switch assembly 61 or press the pressing switch assembly 62 to render the flashlight to be kept in the state of light emitting or electric breaking.

And particularly, the present invention further is provided on the end having the lamp holder 50 with a movable member 70 movable into the lamp holder 50, the movable member 70 is in the form of an optical lens allowing penetrating of the light source of the light emitting element 20, and is fixedly provided with an electric conductive strip 71, the tailing end of the electric conductive strip 71 is extended into the housing 10 to contact with a contact point 41 of the circuit board 40; the circuit of the light emitting element 20 thus can be electrically connected. Moreover, the lamp holder 50 is provided therein with a restorable spring 80 to normally push the movable member 70 out of the lamp holder 50 to make the movable member 70 normally keep in the position to render the electric conductive strip 71 to contact with the contact point 41 of the circuit board 40.

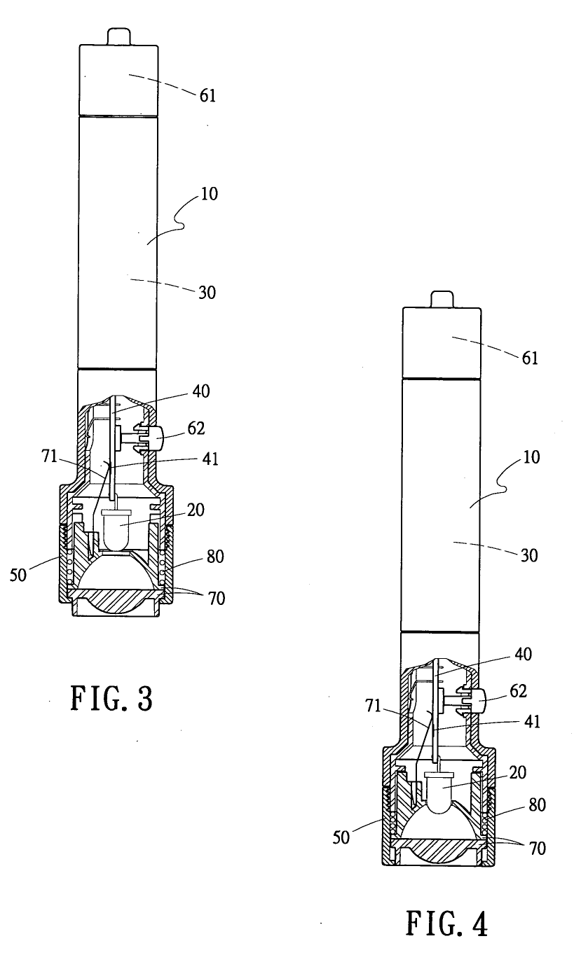

Therefore, when the flashlight is in the state of normal use with the rotating switch assembly 61 or the pressing switch assembly 62 being turned on, such as is shown in FIG. 3, the movable member 70 is kept in the position being pushed out of the lamp holder 50 under the action of the restorable spring 80, this can make contact of the electric conductive strip 71 with the contact point 41 of the circuit board 40; thus the light source can be created by electric connecting of the light emitting element 20 effected by the electric conductive strip 71.

On the contrary, when the user lays the flashlight upside down with its lamp holder 50 facing downwards to be not in use for a moment, such as is shown in FIG. 4, the rotating switch assembly 61 or the pressing switch assembly 62 of the flashlight is not yet turned off at this time, however, by the weight of the flashlight, the movable member 70 is moved into the lamp holder 50 correspondingly to release the electric conductive strip 71 from contact with the contact point 41 of the circuit board 40, hence the light emitting member 20 is electrically broken, thereby a function of saving electric energy can be obtained.

When the user picks up the flashlight thereafter, such as is shown in FIG. 3, the movable member 70 immediately is kept in the position being pushed out of the lamp holder 50, thereby the flashlight can restore the normal state of use to emit light, and the above stated effect of convenient use and saving electric energy can be achieved.

In conclusion, according to the description disclosed above, the present invention provides a more practicable structure of flashlight. While the embodiment and drawings given are only for illustrating the present invention, and not for giving any limitation to the scope of the present invention; it will be apparent to those skilled in this art that various modifications or changes without departing from the spirit of this invention shall also fall within the scope of the appended claims.

1. A flashlight comprising:
a housing provided with a switch and receiving a battery, said housing is provided on one end thereof with a lamp holder, and is provided in said lamp holder with a light emitting element;
an electric circuit board provided in said housing to form connection of said light emitting element with said battery;
a movable member provided to slip over one end of said lamp holder and being movable into said lamp holder, and being fixedly provided with an electric conductive strip;
a restorable spring provided in said lamp holder to normally push said movable member out of said lamp holder to make said movable member normally keep in a position to render said electric conductive strip to contact with a contact point of said circuit board;
thereby when said switch is turned on, a light source is created by electric connecting of said light emitting element effected by said electric conductive strip; when said movable member is moved into said lamp holder, said electric conductive strip is released from contact with said contact point of said circuit board to render said light emitting member electrically broken,

2. A flashlight as in claim 1, wherein: said housing is cylindrical; said lamp holder is screw connected with one end of said housing, said housing is provided on the other end thereof with a rotating switch assembly, said other end is an end opponent to said lamp holder; said rotating switch assembly controls connecting of said electric circuit board with said battery.

3. A flashlight as in claim 1, wherein: said housing is cylindrical; said lamp holder is screw connected with one end of said housing, said housing is provided near to said lamp holder with a pressing switch assembly, said pressing switch assembly controls connecting of said electric circuit board with said battery.

4. A flashlight as in claim 1, wherein: said housing is cylindrical; said lamp holder is screw connected with one end of said housing, said housing is provided on the other end thereof with a rotating switch assembly, said other end is an end opponent to said lamp holder, and said housing is provided near to said lamp holder with a pressing switch assembly; said rotating switch assembly and said pressing switch assembly control connecting of said electric circuit board with said battery.

5. A flashlight as in claim 1, wherein: said movable member is in the form of an optical lens allowing penetrating of said light source of said light emitting element.
